(19) United States
(12) Patent Application Publication
(10) Pub. No.: US 2016/0292992 A1
(43) Pub. Date: Oct. 6, 2016

(54) SYSTEM FOR MONITORING AND RECORDING HAND HYGIENE PERFORMANCE

(71) Applicant: GOJO Industries, Inc., Akron, OH (US)

(72) Inventors: Henry Michael Ortiz, Aliso Viejo, CA (US); Timothy Michael Cambier, Uniontown, OH (US); Shawn A. Warthman, Avon Lake, OH (US)

(21) Appl. No.: 15/177,719

(22) Filed: Jun. 9, 2016

Related U.S. Application Data
(63) Continuation of application No. 13/840,835, filed on Mar. 15, 2013.

(51) Int. Cl. G08B 21/24; G08B 25/10

(52) U.S. Cl. CPC G08B 21/245; G08B 25/10

(57) ABSTRACT

A system for monitoring and recording hand hygiene performance is configured to monitor and record information generated by the operation of dispensers to assess behavior of a group to identify overall hygiene performance. The system includes a plurality of wireless communication devices, with a first number of the wireless communication devices being disposed within or adjacent to dispensers and operatively configured for sensing, monitoring, and reporting information about the status and operation of the dispensers. A hierarchal communication network for access to a central host database, a data processor, and a hygiene management software application operatively configured to create hygiene management reports of hand hygiene rate metrics based upon the monitored dispenser data and a method of providing a user interface. Based on the various computed hand hygiene rates, a hand hygiene improvement metric that identifies the improvement in hand hygiene rates over time is also calculated by the system.

### CROSS REFERENCE TO RELATED APPLICATIONS

This application claims priority to, and the benefits of, U.S. application Ser. No. 13/840,835, filed on Mar. 15, 2013 (Attorney Docket Number 33298/05071-GOJ.P.361), which is incorporated by reference herein in full.

### TECHNICAL FIELD

The present invention relates to personal hygiene. Particularly, the present invention relates to a management system for remotely monitoring data generated by a dispenser. More particularly, the present invention relates to transmitting monitored information to a database where management information reports documenting hand hygiene performance, including a hand hygiene improvement metric, are generated.

### BACKGROUND ART

The present invention relates to a method for monitoring hygiene, and more particularly hand hygiene, such as in a food, healthcare, general office or industrial environment to determine the frequency and interval of hand washing practices. The present invention described is a remote monitoring system capable of monitoring and recording data generated by the function of a soap or sanitizer dispenser, including the amount of improvement in the compliance rate from a previous time period to a current time period, and in turn creates management information reports that document hand hygiene practice behavior.

In recent years, the public's growing concern with disease and its transmission has generated increased public awareness regarding the need for sanitization and hygiene in general.

In addition, various marketers in the cleansing and hygiene industry believe that with increased public awareness and education, cleansing, and especially hand cleansing, will continue to be a subject of increasing scrutiny. As a result, the healthcare, food preparation, food services, and the hotel and travel industries have been forced to examine their cleansing processes and procedures, as well as their efficacy.

Whether it is the possible transmission of E. coli in the food services industry, the rhinovirus in elementary schools, healthcare acquired infection (HAI) related diseases within healthcare facilities, or even the transmission through ordinary physical contact made during a simple handshake, there are numerous studies citing hand hygiene as an effective way to guard against disease transmission. The CDC (Center for Disease Control) has concluded that hand washing is the single most important factor in the prevention of disease and in the reduction in the spread of infection. Thus, the need for a system for assessing the effectiveness of proper hand hygiene is therefore well understood.

Non-compliance with established hand washing protocols is a serious problem, which can lead to expensive and sometimes fatal consequences. Each year, food-borne illness strikes 76 million people, causes 325,000 hospitalizations, and kills thousands. In particular, 70% of the outbreaks originate in the food service sector, while 40% of these outbreaks are the result of poor hand washing and cross-contamination (oral/fecal).

The CDC estimates that healthcare acquired infections (HAI) cost on average $35,000 per incidence in extended medical costs. With respect to hospitals and hospital staff, it is estimated that the rate of hand washing non-compliance among healthcare workers is an approximately 70-80%.

Recently verified by research at the University of Pennsylvania School Of Medicine, the CDC also estimates that the occurrence of HAI infections can be reduced by one-third when infection control practices that include hand hygiene compliance measurement are implemented. That is, the CDC estimates that one third of all HAI infections are caused by poor adherence to infection control practices, such as hand washing. The CDC estimates that the annual costs to the public health system, personal pain and suffering, and lost productivity that result from food-borne illness and HAI infections are estimated to be as high as $83 billion annually. Approximately two million hospital patients annually become infected while being treated for another illness or injury, with approximately 120,000 of these patients dying. The CDC estimates that these infections or illnesses add nearly $4.5 billion to U.S. healthcare costs annually.

More specifically, in January 2004, Pennsylvania hospitals began submitting data on HAIs or healthcare acquired infections to the Pennsylvania Health Care Cost Containment Council (PHC4). During this initiative, the first year of data collected provides information for all parties involved in the delivery and payment of hospital care. In 2004, Pennsylvania hospitals reported the occurrence of 11,668 HAI infections, or 7.5 HAI infections per 1,000 patients that were admitted to Pennsylvania's general acute care hospitals. Of this amount, 15.4% or 1,793 of these patients died. In addition, $2 billion in additional hospital charges and 205,000 additional hospital days were associated with the hospital admissions in which these infections occurred.

In a study in the Journal of Infectious Diseases in Children, it was reported that fecal coliforms were detected on the hands of approximately 20 percent of the daycare staff that was evaluated. Further, a third of the facilities studied had poor hand washing systems and no policy in place for hand washing before eating or after playing outside.

In addition, the Food and Drug Administration (FDA) assists approximately 75 state and territorial agencies and more than 3,000 local departments that assume primary responsibility for preventing food borne illness, and for licensing and inspecting more than one million establishments that employ over 12 million employees within the retail segment of the food industry. As such, the FDA maintains a model food code that is used to assist food control jurisdictions at all levels of government by providing them with a scientifically sound technical and legal basis for regulating the retail segment of the food industry. For example, according to the model food code, a person must wash his or her hands after using the bathroom for a minimum duration of 20 seconds, with concentration on the fingers and fingernails. However, many operators in the commercial food service industry have expanded on the FDA model code with more rigorous protocols.

The monitoring of hand washing by individuals who are identified by electronic badges or data tags and then associating the badges or tags and individuals with the use of hygiene dispensers is well known in the art. However, badge-based hand wash monitoring systems have experienced only minor acceptance in the marketplace due to their complexities, which result from the management of the badges, as well as personal privacy concerns caused by the use of such badges.

Alternatively, usage indicating or counting dispensers, such as that disclosed in U.S. Pat. No. 6,375,038 B1, provide a soap dispenser 10 having a usage indicator that tracks the number of times the dispenser has been used. Moreover, usage indicating or counting dispensers have experienced minor acceptance in the marketplace due to the burden of the manual recording and analysis of the count data from each dispenser. For example, a typical healthcare or food processing facility could have hundreds of dispensers and a similar number of individuals. Alternatively, a typical food service facility could have only a few dispensers and the food service facility may be linked as a single unit to hundreds or thousands of similar facilities in a chain association.

Moreover, current systems for monitoring and recording hand hygiene performance do not have the ability to calculate a hand hygiene improvement metric from calculated dispenser compliance rates to identify the rate or change in improvement among various hygiene compliance rates.

Therefore, there is a need for an improved system for monitoring and recording hand hygiene performance without the need of the individual responsibility of badge-based identification. In addition, there is a need for group-based hygiene behavior measurements in environments where there are many dispensers and many individuals in distributed locations. Furthermore, there is a need for a system for monitoring and recording hand hygiene performance that is able to compute and display a hand hygiene improvement metric that identifies the improvement among various hygiene compliance rates over time.

### SUMMARY OF THE INVENTION

In light of the foregoing, it is an aspect of the present invention to provide a hand hygiene rate calculation and hand hygiene performance feedback system comprising a computer network with application software with an application software administrative center operative on the computer network, which allows an application software user to direct the application software to interface with and query data or databases at sites or locations on the network where raw hygiene data is produced or stored, and with an application software user interface, which enables the application software user to enter or choose from a list a reference hand hygiene compliance rate, a comparison hand hygiene compliance rate, and an elapsed time period, such that execution of the application software will cause mathematical operations to be performed upon raw hygiene data from locations queried as selected by the applications software user, wherein the system outputs a hand hygiene improvement metric calculated as the difference between the reference hand hygiene compliance rate and the comparison hand hygiene compliance rate, that is divided by the elapsed time period, wherein the application software is configurable via the application software administration center to address, interface with and query databased raw hygiene data residing anywhere on the computer network that the application software is located, and which raw hygiene data contains time stamp and hygiene event data, which includes the number of times a particular soap or sanitizer dispenser or group of particular soap or sanitizer dispensers have been used, and is stored in a publicly available database format, and wherein the application software is configurable to perform mathematical operations on raw hygiene data, such that only the raw data required to assess the reference and comparison hand hygiene compliance rates of a group of individuals or team of co-workers or personnel from which the raw data originated is operated on, the raw data includes time stamped hand hygiene event data, which includes the number of times a particular soap or sanitizer dispenser or group of particular soap or sanitizer dispensers have been used, wherein an individual or individual personnel identification information and any other information which links individual or individual personnel identification to the raw hygiene data is necessarily excluded from mathematical operation by the application software.

### BRIEF DESCRIPTION OF THE DRAWINGS

These and other features and advantages of the present invention will become better understood with regard to the following description, appended claims, and accompanying drawings wherein:

FIG. 1 is a block diagram of a hand hygiene monitoring system showing one dispenser element in accordance with the concepts of the present invention;

FIG. 2 is a block diagram of a hand hygiene monitoring system showing multiple dispenser elements in multiple locations in accordance with the concepts of the present invention;

FIG. 3 is a block diagram of a hand hygiene monitoring system showing multiple dispenser elements in multiple locations, including a wireless communication relay hub representing a number of 1 to n of possible relays in accordance with the concepts of the present invention;

FIG. 4 is a variation of the hand hygiene monitoring system where the database, data processor management application software, and user interface are contained locally in close proximity to the monitored dispenser elements in accordance with the concepts of the present invention;

FIG. 5 is a user interface screen that allows a user to manage various hygiene compliance systems associated with various locations where the hygiene compliance system is installed in accordance with the concepts of the present invention;

FIG. 6 is a user interface screen that displays hand hygiene performance data for a selected location in accordance with the concepts of the present invention;

FIGS. 7A-B show a user interface screens that enables the selection and formatting of various criteria associated with the calculation hygiene compliance rates and/or hygiene improvement metrics in accordance with the concepts of the present invention;

FIG. 8 is a user interface screen that displays the hygiene compliance rate for various locations using the system in accordance with the concepts of the present invention;

FIG. 9 is a user interface screen that displays the various attributes, including usage, that are associated with each hygiene compliance monitoring component provided by the system, including dispensers and people counters, in accordance with the concepts of the present invention;

FIG. 10 is a user interface screen that allows a user to set an alarm, such as an email message, which is sent to a user when a predetermined trigger action associated one or more hygiene compliance monitoring components occurs in accordance with the concepts of the present invention; and

FIG. 11 is a user interface screen that allows a user to select one or more performance reports or dashboards to automatically display in predetermined intervals as a slideshow set by the user in accordance with the concepts of the present invention.

### DETAILED DESCRIPTION

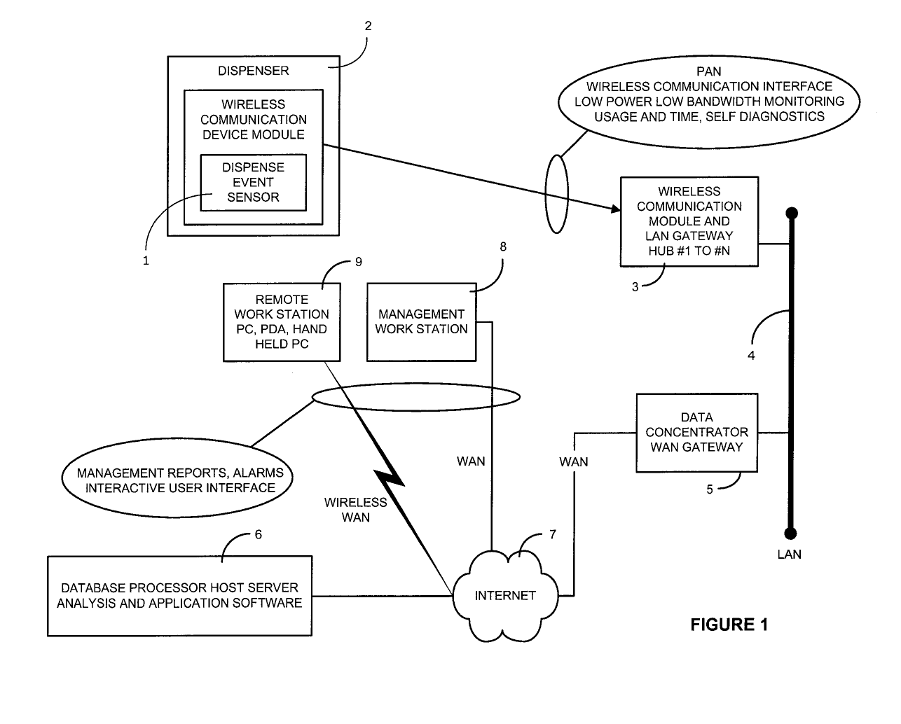

A system for monitoring and recording hand hygiene performance is shown in FIG. 1 of the drawings. Specifically, FIG. 1 shows data as it is traced from event sensor 1 in the dispenser 2 to a LAN (local area network) gateway hub 3, through the LAN 4 to a data concentrator WAN (wide area network) gateway 5. Data is also traced to the database processor host server 6, where output management reports and alarms 10 are provided. The system 10 also traces data to a WAN 7 and then to a fixed workstation 8 or portable communication devices 9, such as personal computer or personal digital assistant, that provide a user interface.

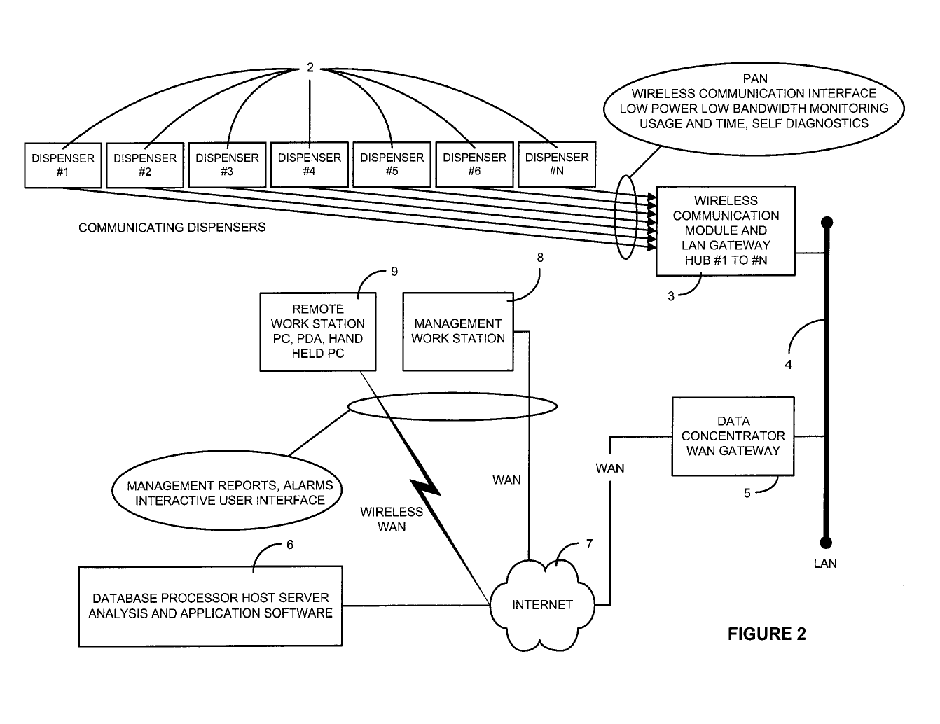

A system with multiple dispensers 2 in multiple locations within a facility is shown in FIG. 2, and includes a data flow as previously described.

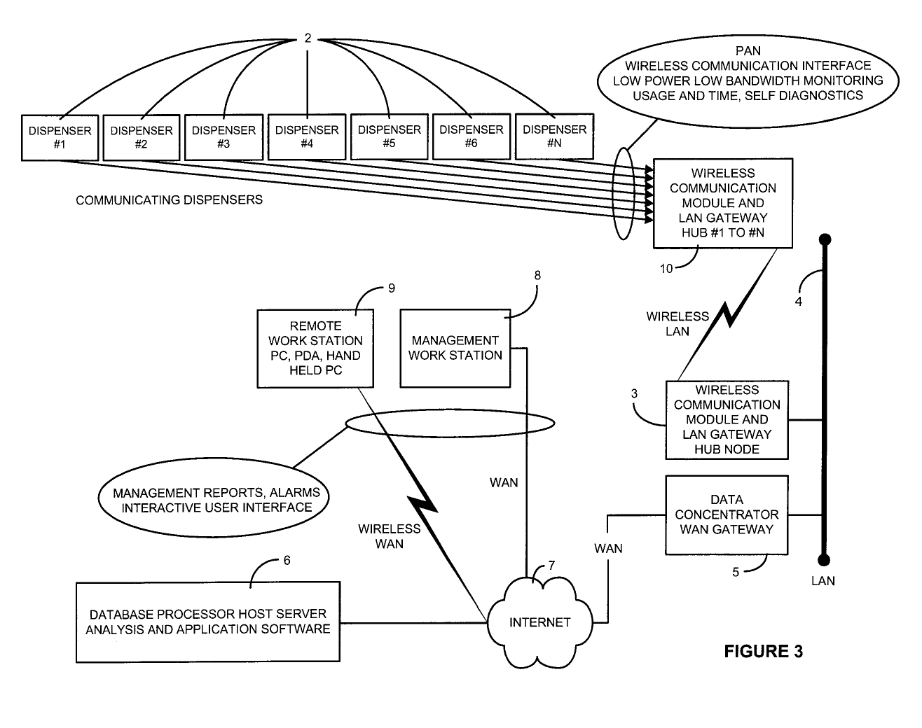

A system with multiple dispensers 2 in multiple locations within a facility 20 and having the data flow as previously described is shown in FIG. 3. Specifically, the system includes a wireless communication relay hub 10 that represents a number of 1-to-n possible relays in the network that serve to transmit data over long distances from the dispensers to the WAN gateway.

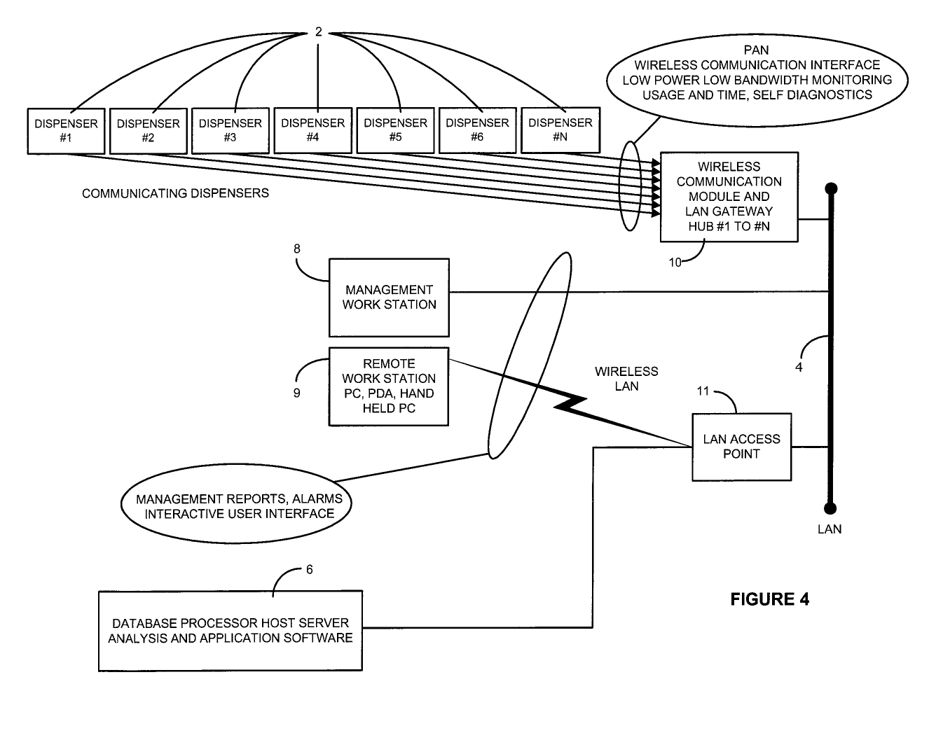

The previously described system for monitoring wireless communication devices sets forth that there is communication to a wide area network (WAN) for access to a remote, central host database, data processor, and management application software and a method to provide a user interface. However, a variation of the system is shown in FIG. 4, where the database, the data processor management application software, and the user interface are contained in close proximity to the monitored dispensers that are connected directly to the LAN or connected wirelessly to the LAN through a wireless access point 11.

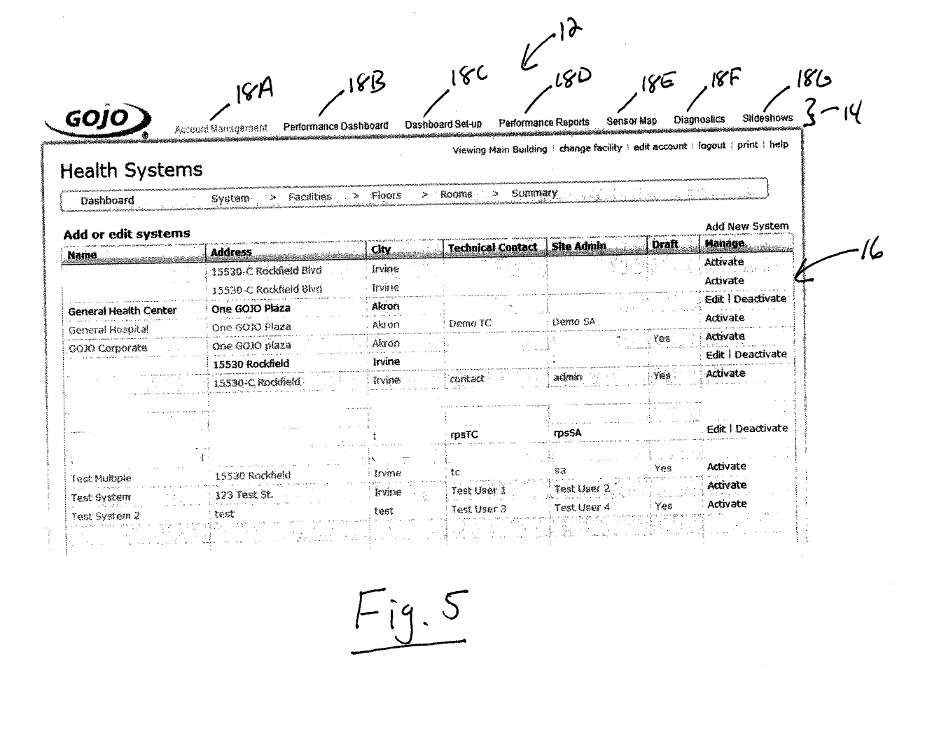

A method of providing a user-friendly interface to the system for the purpose of determining hand wash behavior through the monitoring of the usage of individual dispensers and other hand hygiene monitoring components is shown in FIGS. 5-11 of the drawings. Furthermore, the user interface may be displayed on any suitable display, such as an LCD (liquid crystal display) provided by a standalone or portable computer device, for example that is provided as part of the system. Moreover, the user interface is configured so as to be interactive, allowing hygiene-related information to be organized and displayed in various manners to facilitate the determination and management of hand hygiene compliance protocols.

Specifically, FIG. 5 shows a user interface screen 12 that is divided into an option section 14 and a data display section 16. The option section 14 includes a plurality of options that can be selected by the user via any suitable input device, such as a computer mouse, for example. In one aspect, the options may include, but are not limited to, an account management option 18A, a performance dashboard option 18B, a dashboard set-up option 18C, a performance report option 18D, a sensor map option 18E, a diagnostics option 18F, and a slideshow option 18G. Thus, once an option 18A-G has been selected, the data display section 16 is updated with information that is related to the selected option.

In one aspect, when the account management option 18A is selected, the data display section 16 is updated, as shown in FIG. 5, to show various data fields associated with the various health systems that are being administrated by the system of the present invention. For example, the various data fields may include the name of the healthcare provider or medical system name, address, city, technical contact, site administrator, draft, and the like. In addition, a manage field is also provided, which allows a user of the system to activate or deactivate the hygiene compliance monitoring functions that are associated with a specific entity, such as a healthcare provider, or other location or portion thereof.

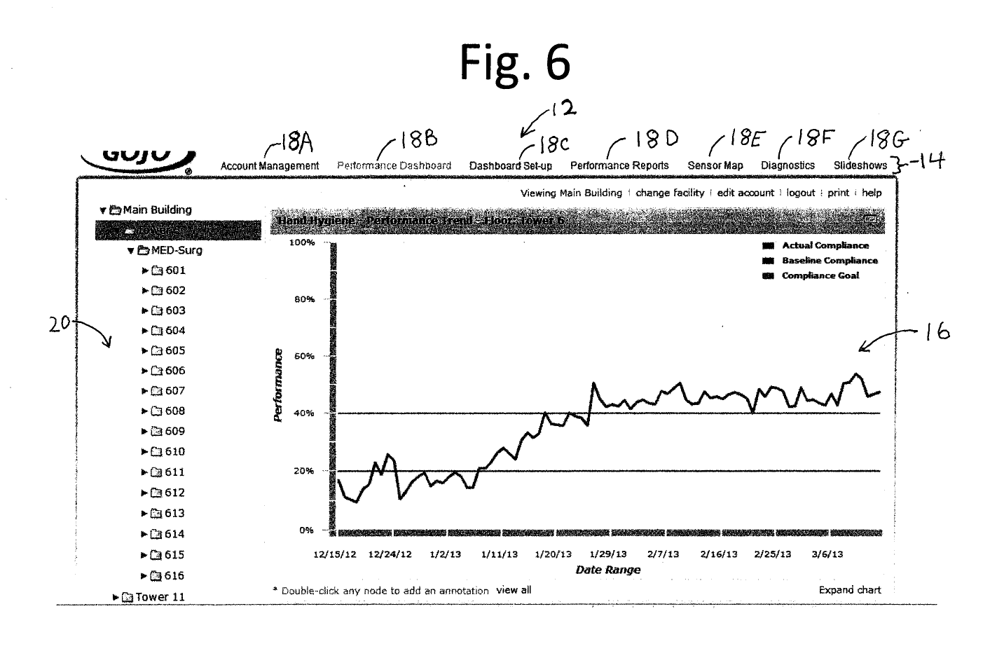

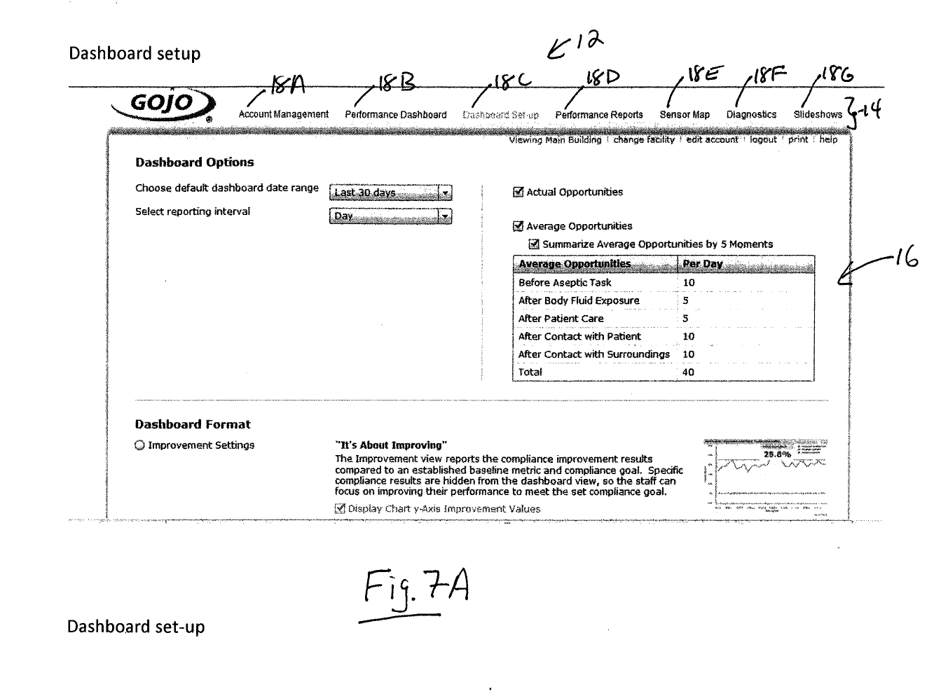

Alternatively, when option 18B is selected, the data display section 16 of the user interface 12 is updated to present a performance dashboard, as shown in FIG. 6. Specifically, the performance dashboard 18B displays various information, such as, graphs showing actual hand hygiene compliance trends, average compliance trends, baseline compliance trends, and compliance goals that are associated with selected rooms or locations in a healthcare facility, as well with specific dispensers and people counters in the selected room or location. As such, the user of the system is able to identify various trends with regard to the hygiene compliance performance of the identified area, such as a surgical room, for example.

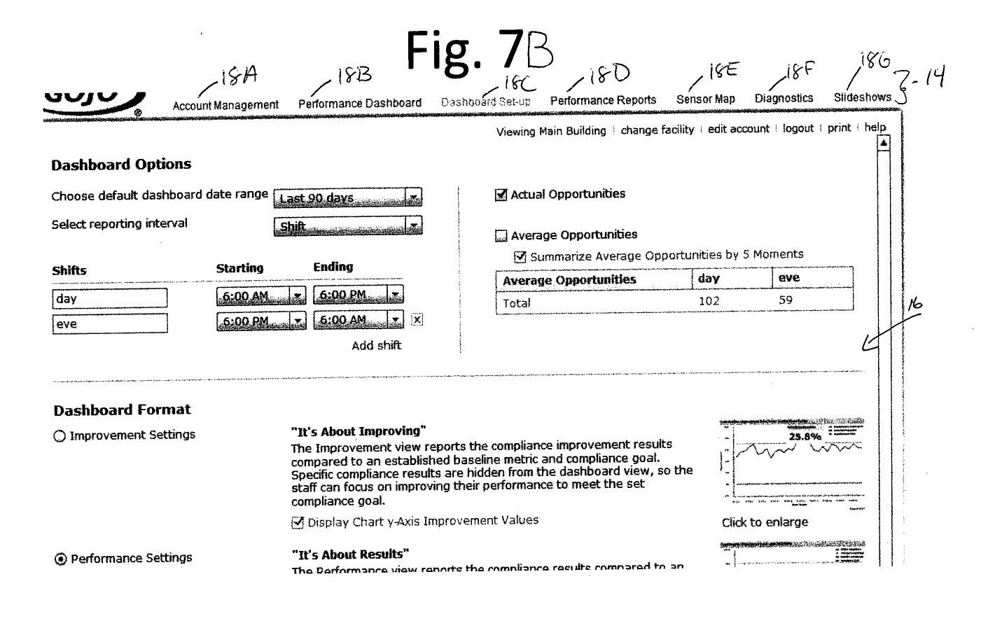

In one aspect, the performance dashboard option 18B allows a user to view such hand hygiene compliance information for such specific rooms or locations, as well as for specific dispensers or people counters by selecting them with their mouse or other input device directly in a location selection section 20 provided by the user interface, as shown in FIG. 6. For example, FIG. 6 shows a user interface screen which is a graphical display representation the hygiene compliance rate over a predetermined period of time (i.e. the number of dispense events or an associated number of hand washes monitored by the system over a defined period of time divided by the metric quotient denominator value entered in step two of the report generation screen described in FIG. 7 or through the alternative embodiment previously described). Specifically, the ordinate displays the quotient value calculated while the abscissa displays the date the calculation is effective.

In addition, when option 18C is selected, the data display section 16 is updated with one or more dashboard screens, as shown in FIGS. 7A-B, allowing for the viewing/selection of various hygiene compliance metrics and associated options, including metrics and options associated with a hand hygiene improvement metric, and data options associated therewith. In one aspect, the dashboard setup option 18C may also allow a user to select a hand wash quotient metric, the insertion into the database of the denominator value of that quotient and the creation of hand wash performance data that is selectable in graphical or tabular formats. In particular, the first step one in the process is to select the performance metric for available options, examples of which are Hand Washes per Employee Payroll Hour, Hand Washes per Meal Served, Hand Washes per patient visit and Hand Washes per Patient Bed Day. Step two is to enter the numerical value of the metric quotient denominator selected in step one and to save it to the database. The software application calculates the quotient of the Hand wash events in the database and the value entered. Step three is to select the type of report to display the hand wash performance data from a selection of 10 options including graphical and tabular.

Moreover, when the dashboard set-up option 18C is selected, the user is permitted to specify how various hygiene compliance-related data is presented and displayed, including but not limited to, dashboard date range, reporting interval, actual hygiene opportunities, and average hygiene opportunities are displayed.

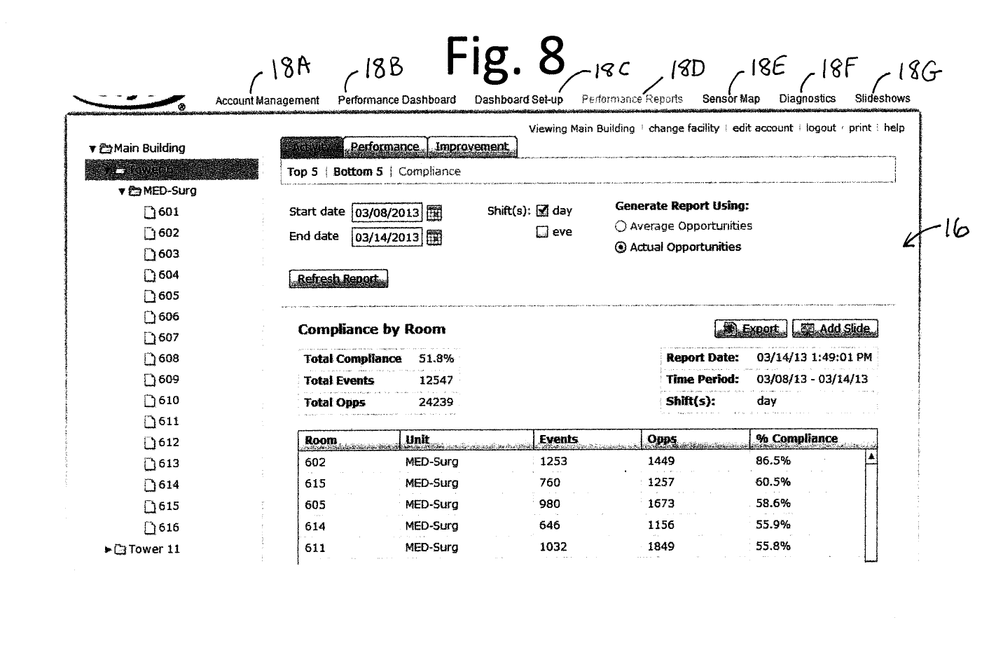

Alternatively, when performance reports option 18D is selected, the data display 16 of the user interface 12 is updated to present various report options, as shown in FIG. 8. This option allows the user to view various data, including the number of hygiene events, opportunities, and compliance rate/percentage for various locations implementing the system.

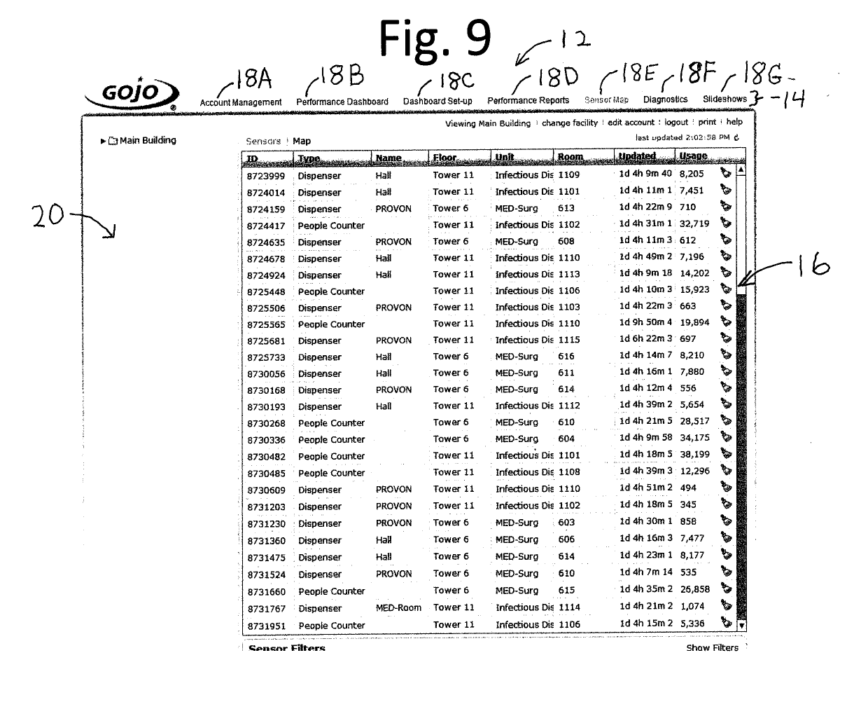

When the sensor map option 18E is selected, the data display section 16 of the user interface 12 is updated to present various information relating to the location of each component utilized by the hygiene compliance system of the present invention, as shown in FIG. 9. Specifically, when the sensor map option 18E displays an ID code field, a hygiene compliance monitoring component field, a hygiene compliance monitoring component name field, a floor location filed, a location unit field, a room field, a last update field, and a usage quantify field. Specifically, the ID field uniquely identifies the specific ID code associated with a specific hand hygiene monitoring component (i.e. dispenser, people counter, etc.). In addition, the particular name of the hygiene compliance monitoring component is identified in the name field. Furthermore, the floor, unit, and room field includes the corresponding information associated with the specific hand hygiene component. In addition, the updated field identifies the time in which the hand hygiene component (i.e. dispenser, people counter, etc.) was last actuated or otherwise triggered. Finally, the usage field identifies how many times the compliance monitoring component has been actuated, such as in the case of a dispenser, the total number of hand hygiene events.

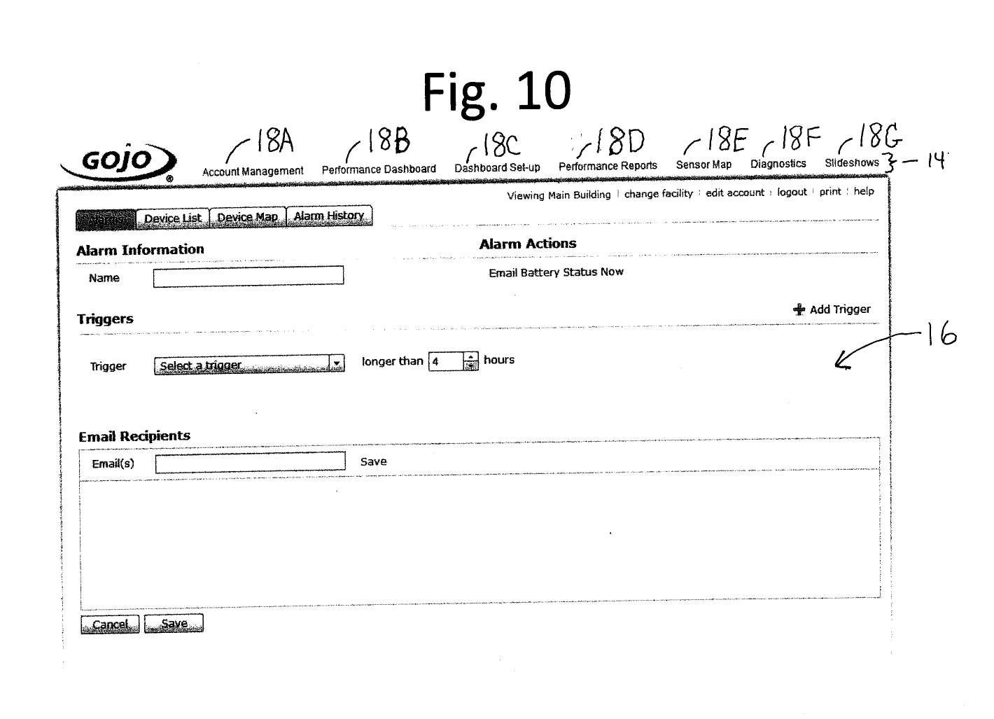

When the diagnostics option 18F is selected, the data display section 16 is updated, as shown in FIG. 10, to display various user selectable tabs, including an alarms tab, a device list tab, a device map tab, and an alarm history tab. When the alarms tab, as shown in FIG. 10, is displayed the user can set an alarm that is associated with one or more hygiene compliance components, such as a dispenser, people counter, and the like, that is triggered according to various criteria. For example, the criteria for triggering an alarm may include the non-report of a hygiene compliance component, a low battery status of the hygiene compliance component, or the usage or actuation of the hygiene compliance component, such as the dispenser or people counter for example. In one aspect, the alarm can be in the form of an email message that is sent to a designated person. Moreover, when the device list tab is selected, the user interface displays the specific device ID code and various other information associated with the device ID of a hand hygiene monitoring component, including whether non-report alarm has been issued with the specific device ID.

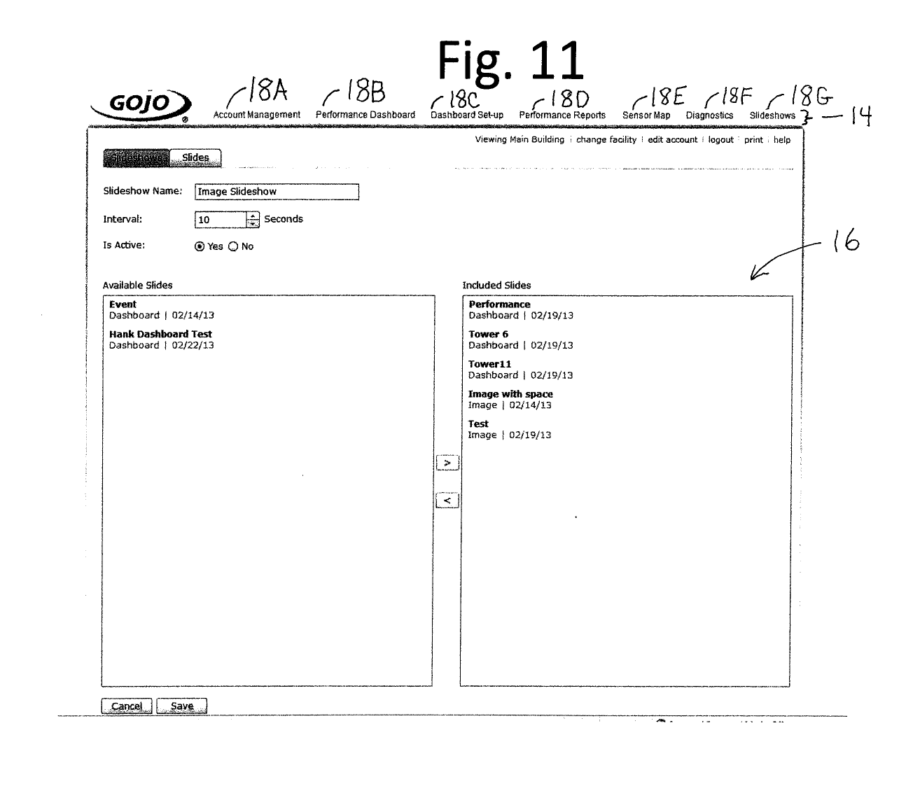

Finally, when the slideshow option 18G is selected, the data display section 16 has is updated to provide a slideshow tab, as shown in FIG. 11, that allows various performance reports provided by option 18D to be displayed in a slideshow format.

In an alternative embodiment, the denominator value and metric definition can be entered automatically into the calculation through an interface with another database. For example, a financial business management software system may provide the metric quotient as payroll hours, patient days, meals cooked, or customers served. A building management software system may provide the metric value in terms of lavatory door openings, or toilet flushes.

The system described herein is a fully integrated wireless data collection, hierarchical network communication, telemetry, database storage, and analysis system. In addition, the system combines wireless radio frequency (RF) communication technology, dispenser operation sensors, network communication infrastructure, database and analysis software, management and reporting software and a method of providing management with an interface with the system for the purpose of determining hand wash behavior through the usage monitoring of individual dispensers.

The system is composed of a plurality of dispensers, whereby each dispenser has an associated wireless communication device fixed in close proximity or integral to the dispenser, such that the detection of a dispenser event is uniquely ascribed or attributed to the dispenser. The associated wireless communication device is a low-power, low-bandwidth radio frequency (RF) wireless communication device, which contributes to long battery life. The wireless communication device has the capability to broadcast information derived from the monitored dispenser event, as well as the time and unique code identifier associated with the dispenser.

The multiplicity of low-power, low-bandwidth wireless RF communication devices create a personal area network (PAN) and communicate with a higher power, higher bandwidth, wireless communication device and local area network (LAN) gateway hub which collects, sorts and relays the data gathered from all the dispensers in its reception range to a facility LAN formed by a plurality of interconnected LAN gateway hubs, which in turn communicate the dispenser data to a data concentrator and wide area network (WAN) gateway. The data concentrator stores the data for periodic communication through the WAN gateway to the WAN as a conduit, and connects with a database data processor host data server, and as such, functions as a data storage device and a software application server. Therefore, the data concentrator analyzes the status and use of the dispenser, generates management reports and alarms, and is accessible through a local or remote portable management access device, such as a PDA (personal data assistant), hand-held computer, or fixed computer workstation, for example.

It should be appreciated that a typical facility could have a large number of dispensers that form a personal area network (PAN) with multiple LAN gateway hubs. The gateway hubs that form a local area network of hubs collect and aggregate the transmitted dispenser data and further communicate the dispenser data through the LAN to a single data concentrator WAN gateway. By example, a typical healthcare facility may have multiple floors with hand wash stations on each floor. Each hand wash station may have multiple dispensers where data from many dispensers is collected by a fewer number of LAN gateway hubs on each floor. Each hub is in communication with the other hubs forming the LAN, collecting data from dispensers in their listening range on each floor and passing the aggregated data through the LAN from floor to floor until the data reaches a single data concentrator WAN gateway.

Thus, the network system is distributed and hierarchical with many dispensers in distributed locations transmitting data hierarchically to a smaller number of Gateway Hubs, which in turn communicate collectively with a single data concentrator and WAN gateway.

The wireless communication devices are short range (30 to 300 feet), radio frequency (RF) radio devices designed for point-to-point communication. The communication from point-to-point can be referred to as a personal area network (PAN). This communication may be a one-way communication or a two-way communication. One-way communication reduces the complexity of network communication management and reduces the cost of individual devices. These devices can, but do not need to, operate in the unlicensed Industrial, Scientific & Medical (ISM) frequency bands. Battery power or harvested energy is the preferred method of supplying energy to these devices, although any suitable power source may be used. These devices are designed to consume little power, drawing less than 10 mA when transmitting, and, therefore, promote long battery life. Because the data creation rate (bandwidth) of the dispensers being monitored is low, the transmission rate of the transmitter is low, typically below 1 kbps. A low transmission rate consumes less power and enables a less sophisticated and less expensive microprocessor. The volume of data is also low and, therefore, requires only a small communication transmission duration, which consumes less power for each transmission. The RF devices suitable for use in the present invention include, but are not limited to, those provided by the following: Atmel Corporation, San Jose, Calif.; LINX Technologies, Grants Pass, Oreg.; Cypress Semiconductor, San Jose, Calif.; RF Monolithics, Dallas Tex.; and Chipcon, Oslo, Norway. However, Radiotronix of Moore, Okla. currently offers the preferred RF device having model number RCT-433-AS, although any other suitable RF device may be used.

Wireless communication devices and LAN gateway hubs suitable for use in the present invention are generally sophisticated RF transceiver devices with internal microprocessors. This sophisticated device is used as a single collecting node or as a relay in a larger hierarchal network of many similar devices. These devices communicate in a way determined by a communication protocol that is stored in the microprocessor. The protocol may be a proprietary design, such as that provided by Zensys or may follow an industry standard that assures interoperability with the IEEE Standard 802.15.4, also known as ZigBee; the IEEE standard 802.11, also known as WiFi; or the IEEE standard 801.16, also known as WiMax. This network typically extends the range and reliability of the sensing system by transferring the data from node to node in the LAN to the final device, a data concentrator and to a gateway that is connected to the WAN. These node devices are more expensive than the RF transmitter discussed previously due to their design complexity. In one aspect, such node devices consume more power, drawing as much as 36 mA, when transmitting and, therefore, require larger batteries or mains power. They are designed to carry a higher data bandwidth of as much as 250 kbps. Such node devices are available from many sources, including but not limited to, Crossbow Technology, San Jose, Calif.; Dust, Berkeley, Calif.; Ember, Boston, Mass.; ZMD GMBH, Dresden, Germany; and Linksys, Irvine, Calif.

The WAN gateway data concentrator is a communication device, which stores data generated by the sensors and data that is communicated to it via the PAN to LAN network. The WAN gateway may contain a computing engine, which processes this data to reconcile conflicting data, and synthesizes and formats the data into a communication protocol that is communicated through the WAN to the data processor host server. The WAN gateway may be programmed for outbound communication in the form of periodically scheduled general data transfers, as well as asynchronous transfers in the event of special case alarms. The WAN gateway may be capable of bidirectional communication with the data processor/server through the WAN for the purpose of confirming that data transfers are completed with integrity or to facilitate reprogramming of the gateway from the data processor host server. Typically, the WAN gateway serves a single facility and typically requires mains power.

It should be appreciated that the Personal Area Network (PAN) is a generic term referring to many possible forms, implementation schemes and hybrids describing a method of connectivity to a Local Area Network (LAN). While the preferred embodiment of the PAN is unidirectional, low-power, low-bandwidth, in the unlicensed frequency bands for the purpose of the extension of battery life, connectivity can be achieved a other radio frequencies, higher power and higher bandwidth. Bidirectional connectivity would allow feedback or control commands to be communicated to the monitored dispenser.

It should be appreciated that the facility local area network (LAN) is a generic term referring to many possible forms, implementation schemes and hybrids describing a method of connectivity to a wide area network (WAN). Several typical examples of connection media are, twisted wire pair cable, fiber optic cable, coaxial cable, wireless radio frequency and power line transmission.

It should be appreciated that the wide area network (WAN) is a generic term referring to many possible forms, implementation schemes and hybrids describing a method of connectivity to a remote database host server computing center. Examples of a wide area network include the Internet, the wired telephone system and the wireless cell phone system.

The previous discussion of the system for monitoring wireless communication devices teach that there is hierarchal network communication to a wide area network for access to a remote central host database, data processor and management application software and a method to provide a user interface. It should be appreciated that the invention may be advantageously practiced using various sub-combinations of the embodiments disclosed. A variation of the system is taught where the database, data processor maintenance management application software, and user interface are contained locally in a workstation communicating to the LAN in close proximity to the monitored dispensers.

It should also be appreciated that another variation of the disclosed embodiment of PAN to LAN to WAN hierarchal network communication progression of the monitored data may be avoided in an alternate embodiment where the dispenser communicates directly to the WAN without first passing data through a LAN or WAN gateway. Examples of this embodiment capability would include WAN communication technology incorporated in the dispenser. Examples are the aforementioned cellular telephone or WiMax communication devices.

Research from within several industries in which compliance with hand hygiene protocol is a requirement, and where hand hygiene performance or hand hygiene compliance rates are measured as a means of management or process control, has shown that disease, death, stress upon the healthcare system, and enormous avoidable expense, may result due to non-compliance with minimum acceptable hand hygiene compliance rates.

Despite the fact that such an understanding exists about the important benefits of compliance with hand hygiene protocols; and also the fact that prior art, technologies, and products exist which teach and provide methods for surveillance and acquisition of discrete hygiene event data, it is evident that the measurement of hand hygiene compliance rate as well as sustainable improvements in hand hygiene performance or compliance rates continue to be elusive. As a result, a significant amount of research has been invested to identify not only a reliable method for measuring hand hygiene performance rates, but also for achieving a measurable and a sustainable improvement in hand hygiene compliance rates.

Continuing, a hand hygiene event is typically described as the washing of one's hands with soap and water, or the rubbing of one's hands with an ethyl alcohol-based hand rub or sanitizer. Both of the aforementioned hand hygiene events require the use of mechanical or electro-mechanical dispensing units, which contain either liquid soap or an ethyl alcohol-based gel. When an employee or co-worker executes a hand hygiene event, the hand hygiene event necessarily requires that either soap or alcohol gel be dispensed out of the dispenser, and into the employee or co-worker's hands so that a hand hygiene event may be performed. Hand hygiene events may be electronically sensed, counted and stored such as depicted in FIGS. 1-4.

Current research, as well as the World Health Organization (WHO), suggests that when seeking to establish or measure hand hygiene performance, it is not only the simple acquisition of discrete hygiene event data or the number or frequency of hand hygiene events that have occurred that is important, but rather it is the number of hand hygiene events that have occurred together with and per the number of hand hygiene opportunities that have occurred that is important. This comprehensive set of information is required to yield a hand hygiene rate quotient or hand hygiene compliance rate. This notion is supported by the WHO's Guidelines on Hand Hygiene in Health Care, which suggests that the hand hygiene quotient or hand hygiene compliance rate should be calculated using the equation: Hand Hygiene Rate=(Quantity of Hand Hygiene Events)/(Quantity of Hand Hygiene Opportunities)*100.

From the equation above, it follows then that if an employee or co-worker has performed hand hygiene or executed a hand hygiene event just once, when in fact there were two distinct hand hygiene opportunities experienced by the employee or co-worker when hand hygiene should have been performed, the employee or co-worker's hand hygiene compliance rate could be computed using the equation above and said to be equal to 50%.

It is thus evident that, given a known quantity of hand hygiene events that have occurred during a given period of time, a denominator value which is equal to the number of hand hygiene opportunities that has also occurred during the same period of time is also required in order to obtain a hand hygiene quotient or hand hygiene compliance rate.

The WHO's Guidelines on Hand Hygiene in Health Care reinforce the importance of considering the quantity of hand hygiene events in addition to the number of hand hygiene opportunities experienced by healthcare workers when measuring, establishing, and evaluating hand hygiene performance and hand hygiene compliance rate. To support this position, the WHO's Guidelines on Hand Hygiene in Health Care set out to define the five hand hygiene moments, or hand hygiene opportunities, either before or after which a healthcare worker should perform hand hygiene. The WHO defines these five moments or opportunities as: Moment 1) Before touching a patient; Moment 2) Before a clean/aseptic procedure; Moment 3) After body fluid exposure risk; Moment 4) After touching a patient; and Moment 5) After touching patient surroundings.

While there are many ways to determine the number of hand hygiene events which transpire over time, within the healthcare community and within healthcare facilities, the quantity of hand hygiene opportunities, such as defined above and which have occurred over a specific period of time is typically established via human observation. The utilization of human observation in determining a hand hygiene opportunity quantity requires that specific staff or co-workers be trained in acutely recognizing when a hand hygiene opportunity has occurred, as well as how to observe co-workers unobtrusively, or even covertly so that an accurate assessment of the number of hand hygiene opportunities which has occurred during an observation session may be obtained. These trained observers are then responsible for occasionally observing the activities of co-workers in their day-to-day activities and counting the number of hand hygiene opportunities, which occur during an occasional observation session. Thus, a hand hygiene compliance rate may be obtained via human observation by taking the ratio of hand hygiene events, however determined, to observed hand hygiene opportunities. The WHO's Hand Hygiene Technical Reference Manual suggests that approximately 200 observed hand hygiene opportunities per observation session are required to obtain hand hygiene compliance rates, which may be reliably compared.

Thus, the WHO's Guidelines on Hand Hygiene in Health Care specify a methodology for determining a hand hygiene compliance rate, an equation to be used for computing a hand hygiene compliance rate, which utilizes the quantity of hand hygiene events in the equation numerator and hand hygiene opportunities in the equation denominator, and also provides a definition for hand hygiene opportunities. Furthermore, the WHO's Hand Hygiene Technical Reference Manual establishes how human observation should be performed in order to observe and count hand hygiene opportunities that have occurred during an observation session in order to establish a hand hygiene opportunity value or hand hygiene compliance equation denominator value.

It follows then, that the WHO's methodology and equation for determining hand hygiene compliance rate may be applied to areas outside of healthcare where hand hygiene compliance is not only a requirement, but also where a minimum hand hygiene compliance rate has been established, the number of discrete hand hygiene events performed by co-workers may be observed or electronically acquired, and also where a definition of hand hygiene opportunities may be established so that a hand hygiene rate denominator value may be determined.

In one aspect, it should be noted that within a hospital or similar healthcare facility or a restaurant or food-processing facility for example, there may be many different work areas, which, by their very nature, provide different types of hand hygiene opportunities. Furthermore, different work areas within the same facility may demonstrate wide ranges in the typical quantity and frequency of hand hygiene opportunities.

Specifically, within hospitals or similar healthcare facilities there are defined areas or wards that address the special or specific needs that are typical of various groups of the infirm or injured. For example, within hospitals the typical number of hand hygiene opportunities varies dramatically by hospital ward type. In view of this, research literature points out that it is not uncommon to have a typical average of only eight hand hygiene opportunities per patient-hour in a pediatric ward. In contrast, the typical or average number of hand hygiene opportunities per patient-hour may be as high as or higher than twenty in an intensive care ward. It can therefore be seen in the previous example that an identical number of discrete hand hygiene events in the pediatric ward and the intensive care ward will yield completely different hand hygiene rates due to the large difference in typical hand hygiene opportunity values.

Utilization of the previously stated equation for determining hand hygiene compliance rate, which necessarily includes the number of hand hygiene opportunities, will yield a normalized hand hygiene rate which allows the comparison of hand hygiene compliance rates against a target hand hygiene compliance rate, or comparison of hand hygiene compliance rates between co-workers regardless of the disparity in the number of hand hygiene opportunities that are characteristic of each co-worker's work area.

While globally-accepted methodologies for determining the hand hygiene compliance rate of individual employees or co-workers exist, historically they have been difficult to implement in a broad and scalable fashion within large facilities or across even small groups of employees or co-workers for a variety of reasons. For example, the human observation method is cost prohibitive and non-scalable over large groups of co-workers or across multiple facilities. Additionally, research has shown that hand hygiene performance or compliance rate results obtained via human observation are inaccurate due to impartiality of the observer and other reasons, such as the well-known Hawthorne Effect. But perhaps more importantly, surveillance methods, such as human observation, which may identify and single-out discreet individuals and/or their activity, are inherently difficult to implement due to co-worker rejection that results from concerns regarding the invasion of their privacy and other related social issues. While electronic surveillance methods have simplified the monitoring of discreet individuals, these electronic surveillance methods do not address, and may even exacerbate, co-worker concerns over privacy invasion. Despite these challenges, human observation remains the standard method for determining the quantity of hand hygiene opportunities that have occurred over a specific period of time.

The invention disclosed herein is an improvement over electronic hygiene event surveillance or monitoring devices in that although it utilizes data-based hygiene event data which may have been electronically acquired, it necessarily excludes utilization of data which could be used to identify or single out individual employees or co-workers in favor of group-based hygiene behavior measurements. The disclosed invention is an improvement over existing devices because it handles data-based hygiene event such that the hygiene event data for groups or teams of co-workers are aggregated into a single set of hygiene events such that the aggregated data is said to be the hygiene event data for an entire and specific group or team. In this way, the disclosed invention preserves the privacy of discrete individuals while at the same time allowing for an assessment of hand hygiene performance.

The invention disclosed herein relies on the globally accepted human observation method for determining the quantity of hand hygiene opportunities, which have been experienced by an employee or co-worker over a specific period of time. The disclosed invention relies on the human observation method to determine the number of hand hygiene opportunities of one or more individuals from within a group or team of co-workers, and then utilize the number or average number of hand hygiene opportunities as representative of the number of hand hygiene opportunities typically experienced by a group or team of co-workers from which the observed number or average number of hand hygiene opportunities was observed. In this manner, a typical number or typical average number of hand hygiene opportunities for an entire group or team of employees or co-workers may be determined.

Furthermore, the disclosed invention is a system which parses data-based hygiene event data which has been acquired from groups or teams of co-workers, such that personal identification of individuals is excluded, aggregates the parsed hygiene event data into a single value for the entire group, and then utilizes an observed value or average value of hand hygiene opportunities for the group as a denominator value such that the hand hygiene compliance rate for an entire group or team of co-workers may be computed. Hand hygiene compliance, or hand hygiene performance for a group or team of co-workers which is computed in the manner disclosed herein is said to be normalized in that, for management and process control purposes, the computed hand hygiene compliance rates may be compared against target compliance rates, and comparison of hand hygiene compliance rates between semi or totally disparate groups or teams of co-workers within large facilities is enabled.

Furthermore, the present invention is configured such that it computes a hygiene compliance improvement value, i.e., change in hygiene compliance rates over an elapsed time, that is based on the difference between one or more previously-computed hygiene compliance rates over a predetermined period of time. For example, the numerator is the difference between one or more previously-computed compliance rates divided by the total amount of time elapsed between the times in which the compliance rates are computed.

Additional research performed by several leading authorities in the area of hand hygiene, including the University of Pennsylvania School of Medicine, and the Columbia University School of Nursing suggests that it is not only surveillance and monitoring of hygiene activity that is necessary to achieve a sustainable improvement in hand hygiene compliance rates of co-workers and personnel, but also that, among other things, frequent and unobtrusive feedback regarding measured hand hygiene performance against hand hygiene performance targets must also be provided to personnel and co-workers. This is not surprising because it follows that it is difficult to define and understand the meaning of performance, or performance improvement without temporal context or frequent feedback, which explains how current performance compares with, or relates to expected performance.

The invention disclosed herein improves upon surveillance and monitoring hygiene data acquisition systems because not only does it provide a means for operating upon raw hygiene data, excluding data which could be used to identify individuals; performing subsequent calculation and determination of a normalized hand hygiene rate quotient; and enabling a hand hygiene performance or rate and a hand hygiene improvement rate to be ascertained, but also the disclosed invention provides a means for graphical rendering of the normalized group hand hygiene compliance rate data over time, as well as hand hygiene improvement rate and distribution of the rendered data over a computer network, such as a corporate intranet, a private network, or the Internet. Distribution of a graphical or similar rendering of the normalized team hand hygiene performance or compliance rate data over a network provides a means for displaying of team hand hygiene performance or compliance rate data on a plurality of network devices, such as monitors.

The pervasiveness of existing computer networks within modern facilities or the ease with which a new or private computer network may be established within any facility, such as a hospital, nursing home, or food-processing facility, enables the display of real-time, or near real-time, rendered normalized team hand hygiene performance or compliance rate data at virtually any place within a facility, as desired. The placement of network devices, such as monitors, in select areas within a facility that are frequently visited by co-workers or team members allows co-workers or team members to see the current group or team hand hygiene performance or compliance rate compared against target compliance rates, as well as hand hygiene improvement rates, and thereby provides the co-workers or team members frequent and unobtrusive feedback regarding the group's or team's hand hygiene performance or compliance rate behavior. The purpose of providing frequent and unobtrusive feedback by the disclosed invention responds directly to a substantial amount of research, which has shown that frequent and unobtrusive feedback regarding hand hygiene performance must be provided to personnel in order to achieve a sustained improvement in hand hygiene performance and hand hygiene compliance rates.

Furthermore, in view of the previous discussion, it is yet another embodiment of the monitoring and recording system to provide a hand hygiene improvement metric or rate that is calculated based on the change in various hand hygiene compliance rates or metrics over a period of time. In one aspect, such improvement metric or improvement rate is calculated by the system for monitoring and recording hand hygiene performance by allowing a user of the application software provided by the system to select, via a visual interface, such as a display, a reference hand hygiene compliance rate or metric and a comparison hand hygiene compliance rate or metric. The calculation of both the reference and comparison compliance rates is carried out in accordance with that discussed above, whereby the hand hygiene compliance rate (i.e. reference and comparison)=(Quantity of Hand Hygiene Events)/(Quantity of Hand Hygiene Opportunities)*100. For example, the reference hand hygiene compliance rate defines a reference value, such as a historical hygiene compliance rate associated with a group of dispensers to which a new or current hand hygiene comparison value is desired to be compared, to allow users of the system to identify the overall change in the two hand hygiene compliance rates over a given time period.

The reference and comparison hand hygiene rates or metrics may be selected from the interface via a list or may be entered directly into the system. In addition, the interface provided by the application software is also configured to allow the user to enter or select a time value that identifies the amount of time that has elapsed between when the hygiene compliance data used for calculation of both the reference and comparison hand hygiene rate metrics was collected or originated. For example, if the data used for calculating the reference hand hygiene rate metric was originated or collected in 2006, and the data used for the comparison hand hygiene rate metric was originated or collected in 2010, then the time value used in the calculation of the improvement metric discussed above would be equal to 4 years.

As such, once the reference and comparison hand hygiene rate metrics have been computed or identified, and the time period between the origination of the data used to calculate such metrics has been selected, the system computes the improvement metric by computing the difference between the reference hand hygiene rate metric and the comparison hand hygiene rate metric, and then dividing this difference by the time that has elapsed since the data used to compute the reference and comparison hand hygiene compliance rates or metrics. This computed hand hygiene improvement metric is then presented to the user via the user interface that is rendered via any suitable display, such as an LCD (liquid crystal display) for example that is provided by the system.

It should also be appreciated that other manners for computing a hand hygiene improvement metric may also be carried out by the system, such as by computing the difference between the reference hand hygiene rate or metric, which serves as a baseline value, and the comparison hand hygiene rate or metric, which serves as a comparison value, and then dividing this difference by the reference hand hygiene rate or metric.

In another embodiment of the present invention, it is provided that a hand hygiene improvement metric or index may be computed by the system using the equation: improvement index=(actual compliance %)−(baseline %); where actual compliance % is equal to actual hygiene events divided by actual hygiene opportunities; and baseline percentage is equal to a base reference percentage value chosen by the user of the system. Specifically, the baseline percentage reflects an approximate average of historical actual hygiene compliance, and as such, this serves as the “baseline” upon which hand hygiene improvement is desired or based.

In still another embodiment of the present invention, it is provided that a hand hygiene improvement metric or index may be computed by the system using the equation: improvement index=(actual hygiene compliance based on average hygiene opportunities %)−(baseline %); where actual hygiene compliance is equal to actual hygiene events divided by average hygiene event opportunities; and baseline percentage is equal to a base reference percentage value that is chosen by a user of the system. In particular, the baseline percentage reflects an approximate average of historical actual hygiene compliance, and as such, this is the “baseline” upon which improvement is desired or based.

In still another embodiment of the present invention, it is provided that a hand hygiene improvement metric or index may be computed by the system using the equation: improvement index=[(actual compliance value−baseline)/(goal−baseline)]*100; where actual compliance is equal to actual events divided by actual opportunities; baseline is equal to a base reference percentage value that is chosen by a user of the system (it should be appreciated that the baseline value should reflect an approximate average of historical actual compliance, and therefore, this is the “baseline” upon which improvement is desired or based); and the goal value is a reference goal percentage value chosen by the user of the system. Specifically, the goal value is based on the baseline (i.e. is relative to the actual hygiene compliance), and should reflect the desired, improved hygiene compliance. The result of using the improvement index method for rendering compliance statistics is that the “baseline value” is rationalized to “0%”, and the goal is rationalized to “100%”.

In a further embodiment of the present invention, it is provided that a hand hygiene improvement metric or index may be computed by the system using the equation: improvement index=[(actual compliance based on average opportunities)−baseline)]*100; where the actual compliance based on average hygiene opportunities value=actual hygiene events divided by the average hygiene opportunities (it should be appreciated that the baseline should reflect an approximate average of historical actual compliance; thus, this is the baseline upon which improvement is desired or based). In addition, the goal value is a reference goal percentage value that is chosen by a user of the system and is based on the baseline value (i.e. is relative to the actual compliance) and should reflect the desired, improved hygiene compliance.

It should also be appreciated that the hand hygiene improvement metric may be calculated using reference and comparison hand hygiene rates or metrics that are associated with various dispensers, individuals, or groups of users of such hand hygiene dispensers for example.

Therefore, one advantage of the present invention is that a system for monitoring and recording hand hygiene performance calculates a hand hygiene improvement metric based on previously calculated reference and comparison hand hygiene compliance rates to allow users to identify their improvement. Still another advantage of the present invention is that the system for monitoring and recording hand hygiene performance computes a hand hygiene improvement metric that identifies the improvement of previously calculated reference and comparison hand hygiene compliance rates over time.

The foregoing description of the system for monitoring dispensers equipped with wireless communication devices for the purpose of determining hand hygiene performance and for the purpose of determining improvements in hand hygiene over a period of time has been presented for the purpose of illustration and description. It is not intended to be exhaustive or to limit the invention to the precise form disclosed. Many modifications and variations are possible in light of the above teachings. Thus, it is to be understood that the drawings and descriptions herein are presented by way of example to facilitate comprehension of the invention and should not be construed to limit the scope thereof. Accordingly, any and all modifications, variations, or equivalent arrangements that may occur to those skilled in the art should be considered to be within the scope of the present invention.

What is claimed is:

1. A remote hygiene performance monitoring system, comprising:
at least one dispenser for dispensing a hygiene product, wherein the dispenser comprises:
a sensor for sensing a dispense event that dispenses the hygiene product, wherein the hygiene product comprises at least one of soap and sanitizer;
a wireless communication device for reporting the dispense event to a data processor through a communication network;
the communication network for receiving dispense event data from at least one dispenser;
a database storing the dispense event data;
the data processor for analyzing the dispense event data, wherein the data processor is configured to determine a compliance rate and a change in compliance rate, and wherein determining the change in compliance rate comprises comparing a compliance rate from a previous time period to a current time period; and
a work station for providing a user interface to the system, wherein the data processor generates at least one of an alarm, a report, and an interactive user interface on the work station associated with monitoring the compliance rate.

2. The system of claim 1, wherein the communication network comprises:
a data concentrator gateway for receiving dispense event data from at least one dispenser, storing the dispense event data, and periodically sending the dispense event data to the database or the data processor.

3. The system of claim 1, wherein the communication network comprises:
at least one gateway hub for receiving dispense event data from at least one dispenser and sending the dispense event data to the database.

4. The system of claim 3, wherein the at least one gateway hub receives dispense event data from a plurality of dispensers associated with an area.

5. The system of claim 1, wherein the communication network is hierarchical and comprises at least one personal area network (PAN), a local area network (LAN), and a wide area network (WAN).

6. The system of claim 1, further comprising:
a first facility comprising a plurality of areas, wherein each area includes at least one dispenser.

7. The system of claim 1, wherein the data processor generates the interactive user interface on a display of the work station, and wherein the interactive user interface enables a user to enter or choose from a list a reference hand hygiene compliance rate, a comparison hand hygiene compliance rate, and an elapsed time period, and wherein the system outputs a hand hygiene improvement metric calculated as the difference between the reference hand hygiene compliance rate and the comparison hand hygiene compliance rate, that is divided by the elapsed time period.

8. The system of claim 1, wherein the data processor generates the report on a display of the work station, and wherein the report comprises the determined change in compliance rate.

9. The system of claim 8, wherein the report comprises the determined change in compliance rate separately for each of a plurality of areas within a facility.

10. The system of claim 1, wherein the data processor generates the interactive user interface on a display of the work station, and wherein the interactive user interface comprises a user interface screen that displays an option section and a data display section.

11. The system of claim 10, wherein the option section of the user interface screen comprises selectable options, comprising:
an account management option that, when selected, displays information associated with health systems administered by the system;
a performance dashboard option that, when selected, displays information associated with hygiene compliance;
a dashboard set-up option that, when selected, displays information associated with hygiene compliance metrics and options;
a performance report option that, when selected, displays information associated with report options;
a sensor map option that, when selected, displays information associated with dispenser locations;
a diagnostics option that, when selected, displays information associated with alarms and devices; and
a slideshow option that, when selected, displays information associated with displaying performance reports in a slideshow format;
wherein after selection of an option, the data display section is updated with the information associated with the selected option;
wherein the displayed information associated with at least one option comprises selectable options to configure the displayed information;
wherein the displayed information associated with at least one option comprises selectable options to configure calculations associated with determining the compliance rate or change in compliance rate; and
wherein the displayed information associated with at least one option comprises data entry fields.

12. The system of claim 11, wherein the information associated with at least one option is separately determined for each of a plurality of areas within a facility.

13. The system of claim 1, wherein determining the compliance rate comprises comparing the dispense event data to hygiene opportunity data.

14. The system of claim 1, wherein determining the change in compliance rate comprises determining a difference between compliance rates associated with different time periods and dividing the difference by a time elapsed between the time periods.

15. The system of claim 1, wherein determining the change in compliance rate is separately determined for each of a plurality of areas within a facility.

16. A remote hygiene performance monitoring system, comprising:
a data processor for analyzing dispense event data from at least one dispenser, wherein analyzing the dispense event data comprises determining a compliance rate and a change in compliance rate, and wherein determining the change in compliance rate comprises comparing a compliance rate from a previous time period to a current time period; and
a work station for providing a user interface to the system, wherein the data processor generates an interactive user interface on the work station for monitoring the determined change in compliance with the hygiene standard.

17. A method of remotely monitoring hygiene performance, comprising:
providing at least one dispenser for dispensing a hygiene product, wherein the dispenser:
senses a dispense event that dispenses the hygiene product;
reports the dispense event to a data processor through a communication network;
receiving dispense event data from at least one dispenser;
storing the dispense event data;
analyzing the dispense event data, wherein analyzing the dispense event data comprises determining a compliance rate and a change in compliance rate, and wherein determining the change in compliance rate comprises comparing a compliance rate from a previous time period to a current time period; and
providing a user interface on a work station, wherein the data processor generates at least one of an alarm, a report, and an interactive user interface on the work station associated with monitoring the compliance rate.

18. The method of claim 17, wherein determining the compliance rate comprises comparing the dispense event data to hygiene opportunity data.

19. The method of claim 17, wherein determining the change in compliance rate comprises determining a difference between compliance rates associated with different time periods and dividing the difference by a time elapsed between the time periods.

20. The method of claim 17, wherein determining the change in compliance rate is separately determined for each of a plurality of areas within a facility.
